(19) United States
(12) Patent Application Publication
(10) Pub. No.: US 2024/0339041 A1
(43) Pub. Date: Oct. 10, 2024

(54) CONVERSATIONAL TEACHING METHOD AND SYSTEM AND SERVER THEREOF

(71) Applicant: ASIA UNIVERSITY, Taichung (TW)

(72) Inventor: WEN-LIAN HSU, NEW TAIPEI CITY (TW)

(21) Appl. No.: 18/625,454

(22) Filed: Apr. 3, 2024

Related U.S. Application Data
(60) Provisional application No. 63/457,413, filed on Apr. 6, 2023.

(51) Int. Cl. G09B 5/06; G10L 15/22; G10L 15/30

(52) U.S. Cl. CPC G09B 5/06; G10L 15/22; G10L 15/30

(57) ABSTRACT

The present application provides a conversational teaching method and system which allows students to have more appropriate responses within a framework including at least one teaching instruction to enhance their learning effectiveness and enjoyment of the conversational teaching.

### CROSS REFERENCE TO RELATED PATENT APPLICATION

This patent application is based on a provisional patent application No. 63/457,413 filed on Apr. 6, 2023.

### FIELD OF THE INVENTION

The present invention relates to language teaching, and more particularly, to conversational teaching method and system.

### BACKGROUND OF THE INVENTION

Learning languages or other course through conversations is quite intuitive. In conventional conversational teaching methods, the computer program plays the role of the teacher and interacts with the student. However, because content of the conversation is open-ended, in one round of conversation, the teacher program is usually unable to keep the student's conversation within the desired teaching objectives.

Besides, because of the script of the conversational teaching is designed to be continuous; in case the conversational in the previous round deviates from of the script, it is difficult to proceed to a next round of the script. When the student has experienced with the described situations, he may not think that learning through conventional conversational teaching is an enjoyable experience.

In view of this problem, it is desired to have a conversational teaching method and system which allows the student to practice more appropriate responsive answers within a framework of teaching instructions to enhance the effective ad enjoyment of conversational teaching.

### SUMMARY OF THE INVENTION

According to an embodiment of the present application, a conversational teaching method is provided. The method comprising: receiving a teaching script, wherein the teaching script includes N rounds, N is a natural number larger than 1, and setting a value of a variable i is 1, where 1<=i<=N; and when i<=N, executing following steps of a i-th round: transmitting a 1St party conversion of the i-th round of the N rounds to a user computer via a network, and having the user computer prompt the 1^{st} party conversion; transmitting a first teaching instruction to the user computer via the network, and having the user computer prompt the first teaching instruction; receiving a 2nd party conversation from the user computer via the network; determining whether the 2^{nd} party conversation matches with at least one of the 1^{st} party conversation and the first teaching instruction; and when it is determined that the 2^{nd} party conversation matches with at least one of the 1^{st} party conversation and the first teaching instruction, increasing the value of the variable i by 1.

Preferably, in order to have the user to practice first language according to familiar second language, wherein the 1^{st} party conversation and the 2^{nd} party conversation are presented in a first language, and the first teaching instruction is presented in a second language.

Preferably, in order to have the user to practice listen and reading comprehension, wherein the step of having the user computer prompt the 1^{st} party conversion in the i-th round comprises one or any combination of following: showing the 1st party conversion in a conversation window by a display; and playing voices of the 1st party conversion by a speaker.

Preferably, in order to have the user to practice speaking of the first language, wherein the step of receiving the 2^{nd} party conversation of the i-th round comprises one of following steps and prompting the 2^{nd} party conversation: receiving voices by a microphone and converting the voices into the 2^{nd} party conversation by voice recognition; and receiving text of the 2^{nd} party conversation by an input device.

Preferably, in order to have the user to practice exemplary answers, wherein when it is determined that the 2^{nd} party conversation does not match with at least one of the 1^{st} party conversation and the first teaching instruction, the conversational teaching method further comprises transmitting a second teaching instruction of the i-th round to the user computer and having the user computer prompt the second teaching instruction, wherein the second teaching instruction includes an example presented in the first natural language.

Preferably, in order to have the user to answer closed to a target, wherein the step of determining whether the 2^{nd} party conversation matches with at least one of the 1^{st} party conversation and the first teaching instruction further comprises comparing the 2^{nd} party conversation with multiple answers of the i-th round, when the 2^{nd} party conversation is like one of the answers, it is determined that the 2^{nd} party conversation matches with at least one of the 1^{st} party conversation and the first teaching instruction of the i-th round.

Preferably, wherein the step of determining whether the 2^{nd} party conversation matches with at least one of the 1^{st} party conversation and the first teaching instruction further comprises: inputting the 2^{nd} party conversation into an AI model for inferencing, when a result of the inferencing matches the first teaching instruction, it is determined that the 2^{nd} party conversation matches at least one of the 1^{st} party conversation and the first teaching instruction of the i-th round.

Preferably, in order to have the user continue the conversational teaching when the user has no idea, the conversational teaching method further comprises one or any combination of following step after the step of prompting the first teaching instruction of the i-th round: prompting an optional command of skipping the i-th round; and prompting an optional command of showing a second teaching instruction of the i-th round.

Preferably, in order to have the user to skip the current round, the conversational teaching method further comprises: receiving the optional command of skipping the i-th round from an input device of the user computer via the network; transmitting the second teaching instruction of the i-th round to the user computer via the network, and having the user computer prompt the second teaching instruction of the i-th round via the network; and increasing the value of the variable i by 1 to end the i-th round, and proceeding to an i+1 round.

Preferably, in order to have the user to read a new teaching instruction, the conversational teaching method further comprises: receiving the optional command of showing the second teaching instruction of the i-th round from an input device of the user computer via the network; and transmitting the second teaching instruction to the user computer via the network, and having the user computer prompt the second teaching instruction of the i-th round.

Preferably, in order to simplify preparation of the teaching script, wherein the first teaching instruction of the i-th round is generated by an AI model according to the 1^{st} party conversation of the i-th round.

Preferably, in order to simplify preparation of the teaching script and to consider the continuity of the teaching script, wherein the first teaching instruction of the i-th round is generated by an AI model according to the 1^{st} party conversation of a first round through the 1^{st} party conversation of the i-th round.

Preferably, in order to simplify preparation of the teaching script and to consider the continuity of the teaching script, wherein the second teaching instruction of the i-th round is generated by an AI model according to the 1^{st} party conversation and the first teaching instruction of the i-th round.

According to an embodiment of the present application, a server of a conversational teaching system is provided. The server comprises a processor for executing instructions stored in non-volatile memory for realizing the conversational teaching method.

According to an embodiment of the present application, a conversational teaching system is provided for realizing the conversational teaching method. The conversational teaching system comprises the server and the user computer.

In summarized, the present application provides a conversational teaching method and system which allows a student learns to have appropriate responses within a framework including at least one teaching instruction to enhance learning effectiveness and enjoyment of the conversational teaching.

Therefore, the conversational teaching method provided by the present application particularly adds the first teaching instruction at step 930 and/or the second teaching instruction at step 950/952 into the conversations. Their functions include but are not limited to following:
1. Limit the range of the user's response to keep the conversation content can be focused on the objective of the teaching instruction of the present round (e.g., the teaching instruction is about asking where the user works.)
2. Provide some suggestions to the user (in some circumstances, suggest the user asks questions proactively or make relevant responses.)
3. Provide an answer (provide a correct answer or a possible rephrasing sentence corresponding to a question provided in the 1^{st} party conversation.)
4. Guide the user to read relevant data or enter to another conversation topic (when the user's answer is not correct, suggest another topic based on its shortcomings.)
5. Give the user some words of encouragement and commendation to boost morale.

### BRIEF DESCRIPTION OF THE DRAWINGS

The advantages and spirit related to the present invention can be further understood via the following detailed description and drawings.

FIG. 1 illustrates a block diagram of a conversational teaching system 100 in accordance with an embodiment of the present application.

FIG. 2 shows a block diagram of a server 110 in accordance with an embodiment of the present application.

FIG. 3 illustrates a block diagram of a user computer 130 in accordance with an embodiment of the present application.

FIG. 4 which is a schematic diagram illustrates the content of a conversation window 400 according to an embodiment of the present application. FIG. 4 contains foreign characters to illustrate the present invention. And these foreign characters form no part of the present invention.

FIG. 5 which is a schematic diagram illustrates the content of a conversation window 500 according to an embodiment of the present application. FIG. 5 contains foreign characters to illustrate the present invention. And these foreign characters form no part of the present invention.

FIG. 6 which is a schematic diagram illustrates the content of a conversation window 600 in accordance with an embodiment of the present application. FIG. 6 contains foreign characters to illustrate the present invention. And these foreign characters form no part of the present invention.

FIG. 7 which is a schematic diagram illustrates the content of a conversation window 700 in accordance with an embodiment of the present application. FIG. 7 contains foreign characters to illustrate the present invention. And these foreign characters form no part of the present invention.

FIG. 8 which is a schematic diagram illustrates the content of a conversation window 800 in accordance with an embodiment of the present application. FIG. 8 contains foreign characters to illustrate the present invention. And these foreign characters form no part of the present invention.

FIG. 9 depicts a flowchart diagram of a conversational teaching method 900 in accordance with an embodiment of the present application.

### DETAILED DESCRIPTION OF THE PREFERRED EMBODIMENT

Some embodiments of the present application are described in detail below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

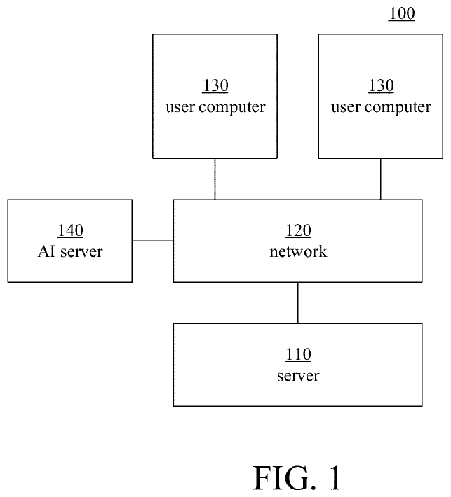

Please refer to FIG. 1, which illustrates a block diagram of a conversational teaching system 100 in accordance with an embodiment of the present application. The conversational teaching system 100 comprises a server 110, a network 120, and multiple user computers 130. The network 120 may be a combination of one or more physical networks which may include one or more interconnected wide-area networks or telecommunication networks and one or more access networks or local area networks connected to the wide-area networks or telecommunication networks. The wide-area networks or telecommunication networks may be wired, or wireless networks provided by telecommunication operators. For examples, they can be Internet, wireless mobile networks such as 3G/4G/5G/6G etc., satellite communication networks such as Starlink or Iridium. The access networks or local area networks may be wired or wireless local area networks, e.g., wired networks compliant with IEEE 802.3 series of protocols or wireless networks compliant with IEEE 802.11 series of protocols. The network 120 is configured to transmit information between the server 110 and the user computers 130.

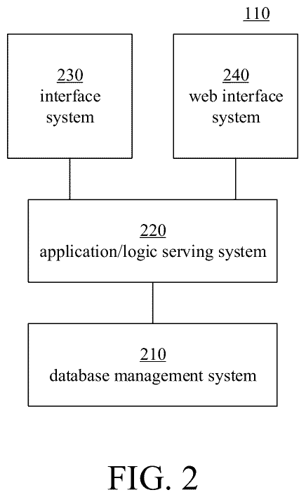

Please refer to FIG. 2, which shows a block diagram of a server 110 in accordance with an embodiment of the present application. The server 100 may include a combination of one or more physical or logical computers. For example, a server may be composed of virtual machines operating at one or more physical computers. In terms of software functions, the server 110 may include DBMS (Database Management System) 210, an Application/Logic Serving System 220, an interface system 230, and a web interface system 240.

The DBMS 210 may include relational DBMS such as common seen MySQL, Oracle, DB2, non-relational DBMS, or even simple spreadsheets. The DBMS 210 is configured to store various data including conversation scripts, conversation histories, user information, user learning historical progress etc.

The Application/Logic Serving system 220 may include common application servers and/or business logic systems, such as Oracle's J2EE server and Microsoft's ASP.NET server. The Application/Logic Serving system 220 may include AI (artificial intelligence) models and their inference modules such as various well-trained neuro-network models. The Application/Logic Serving system 220 may be configured to implement different applications or business logics according to the data stored in the DBMS 210 and to communicate with user computers 130 via the interface system 230 and/or the web interface system. For examples, Enterprise JavaBeans and ASP programs may be configured to implement the methods and steps provided by the present application in order to perform various operations on the data stored in the DBMS 210.

The interface system 230 may include proprietary interface system and/or interface system compliant with industry standard protocols for communications with the applications installed on the user computers 130. The web interface system 240 may use HTTP, HTTPS, and HTML series to communicate with the web browsers installed in the user computers 130. For example, the web interface system 240 may be common-seen Apache Web Server.

The present application does not limit the software implemented by the server 110 to necessarily be the three-tier architecture above. The software may be composed of a single customized package. However, person having ordinary skill in the art of the field of computer domain can understand that the server 110 provided the present application includes the ability to connect to the network 120, the ability to realize the methods and steps provided by the present application, and the ability to store related data.

In one embodiment, the conversational teaching system 100 may comprise an AI server 140 for providing natural language processing capabilities in order to process the computed generation of the contents of teaching instructions. The AI server 140 may be configured to implement a natural language processing model, such as a LLM (large language model). For examples, OpenAI's ChatGPT, Google's Lamda, Meta's LLaMA, or similar models.

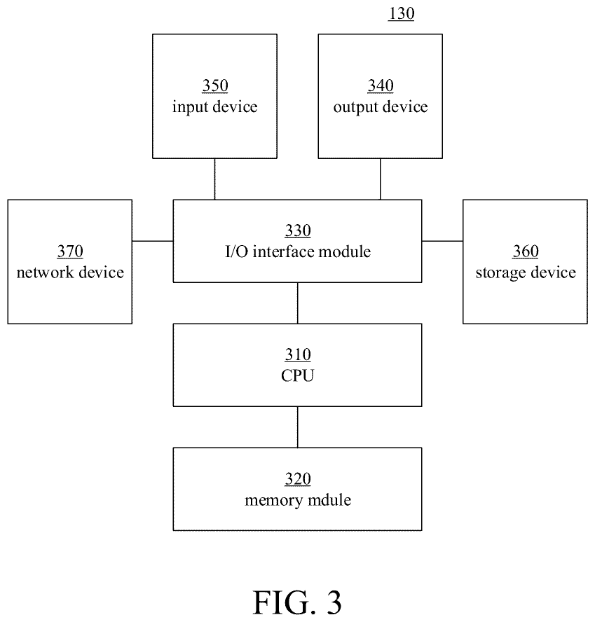

Please refer to FIG. 3, which illustrates a block diagram of a user computer 130 in accordance with an embodiment of the present application. The user computer 130 may be a wearable mobile device, smart phone, personal digital assistant, laptop computer, desktop computer and/or any other form of computer. For examples, the user computer 130 is a computer with Von Neumann architecture and its variants.

The user computer 130 may comprises a CPU (central processing unit) 310, a memory module 320, a I/O (input/output) interface module 330, an output device 340, an input device 350, a storage device 360 and/or a network device 370. The CPU 310 comprises at least one microprocessor, e.g., a microprocessor adapted to one of instruction sets such as RISC-V, x86, x64, ARM, and Alpha. It is configured to execute instructions stored in the memory module 320 in order to control the user computer 130 via an OS (operating system) and/or applications software. And it is configured to control hardware via the OS and/or applications to implement the methods and steps provided by the present application.

The I/O interface module 330 may be compliant with proprietary or industrial standard interfaces, such as USB series, SATA series, SCSI series, PCI series, PCI-Express series etc., for connecting to the output device 340, the input device 350, the storage device 360 and/or the network device 370. The output device 340 is configured to output data from the user computers, such as like sounds, images, data etc. Common output devices 350 include displays, speakers, printers etc. The input device 350 is configured to input data into the user computer 130. Common input devices include touch pads, touch screens, keyboards, mice, microphones, cameras, satellite positioning devices, 2D or 3D scanners etc. The storage device 360 may comprise non-volatile memories, such as hard disk drives, flash memory drives, optical discs, magnetic discs etc. The network device 370 is configured to connect to the network 120. For example, the network device 370 is used connect to an access network of the network 120.

In one embodiment, the network device 370 can be used to determine a position of the user computer 130 via positions of connected routers or wireless base stations. Besides, wireless or satellite telecommunication operators may use multiple base stations or satellites to perform triangulation on the communication signals emitted by the network device 370 to measure a position of the user computer 130. The position of the user computer 130 is transmitted to the user computer 130 via a LBS (location-based service).

The storage device 360 is configured to store the OS and applications for implementing the methods and steps provided by the present application. In one embodiment, the user may connect to the web interface system 240 of the server 110 via a general or a proprietary web browser installed on the user computer 130 to communicate with the server 110. In an alternative embodiment, the user may communicate with the server 110 through a dedicated application installed on the user computer 130 to connect to the interface system 230 via a proprietary communication protocol. Person having ordinary skill in the art of the field of computer may understand that when the methods and steps provided by the present application have to be executed at the user computer 130, the web browser may be configured to execute a part or all of the methods and steps according to web programs such as HTML, Java Bytecode, ASP, java script etc., provided by the server 110. Alternatively, the application installed on the user computer 130 may execute a part of all of the methods and steps based on the instructions and/or data provided by the server 110.

Person having ordinary skill in the art can understand that although the block diagram as shown in FIG. 3 is one of the embodiments of the user computer 130, it can be also applicable to the server 110 as shown in FIG. 1. The server 110 may include devices such as a CPU, network device, memory modules and related devices for realizing the methods and steps provided by the present application.

The conversational teaching system 100 may be configured to realize the conversational teaching method provided by the present application. The conversational teaching method provided by the present application includes displaying a conversation window shown on the user computer 130. The conversation window may be a part of a dedicated application or may be a part of what is displayed in a web browser. In some embodiments, the conversation window may be a dialogue window of instant messaging software. The present application does not limit how to implement the conversation window. The instant messaging software may be WhatsApp, Line, Messenger etc. The data transfer may be done via Short Message Service and/or Multimedia Message Service.

In the conversation window, there is a three-party conversation. In addition to the user's conversation, it also includes a 1^{st}-party conversation and one or more teaching instruction representing a mentor provided by a script executed by the server 110. In one embodiment, the user may choose one script among multiple conversational teaching scripts. Each script includes multiple rounds of conversations. In each round of conversation, the 1^{st} party conversation and the teaching instructions corresponding to the 1^{st} party conversation are included. Only when the user's conversation matches with the 1^{st} party conversation and its one or more teaching instructions, the script is proceeded to a next round by the server 110. Otherwise, another teaching instruction would be presented repeatedly, allowing the user can learn how to respond to the 1^{st} part conversation in the round.

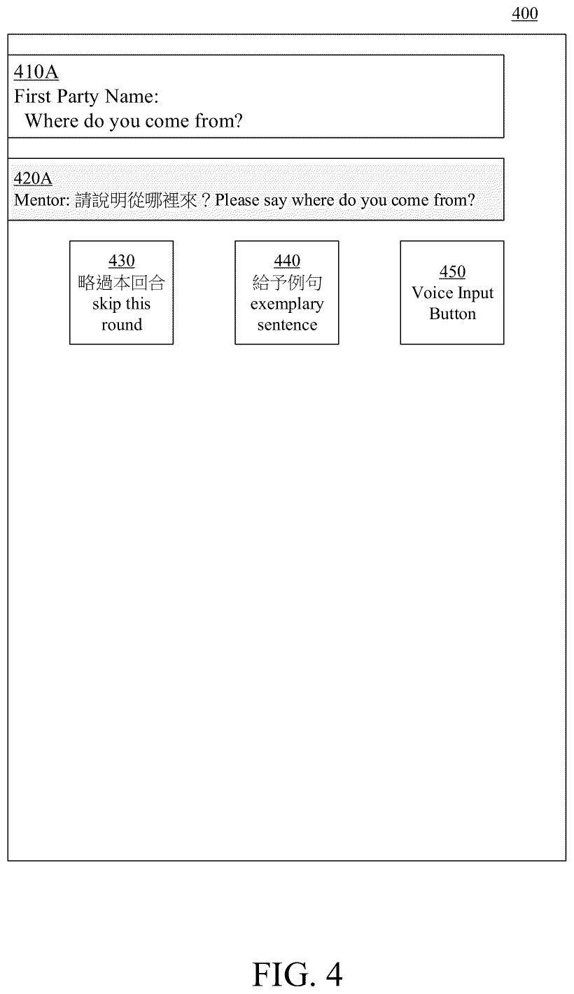

Please refer to FIG. 4, which is a schematic diagram illustrates the content of a conversation window 400 according to an embodiment of the present application. The content of the conversation window includes a 1^{st} party conversation 410A and a first teaching instruction 420A of a first round. In the contents of the conversation window 400, three buttons may be included. They are the “skip this round” button 430, the “exemplary sentence” button 440, and the “voice input” button 450, respectively.

In one embodiment, when the contents of the conversation window are shown by the user computer 130, content of the 1^{st} party conversation 410A may be played by speakers. Person having ordinary skill in the art can understand the user computer 130 may use commonly available text-to-speech synthesizer to read out the content of the 1^{st} party conversation 410A. In an alternative embodiment, the content of the first teaching instruction 420A may be read out, too.

In the embodiment, the 1^{st} party conversation 410A is written or spoken in a first language, while the first teaching instruction 420A is written or spoken in a second language. The second language is a language which is familiar to the user. The first language is a language which the user intends to learn. In this embodiment, both the first and the second languages are natural languages. As shown in FIG. 4, the first language is English; and the second language is Chinese. The purpose of the teaching is to prompt the user (i.e., the student) practices to respond in the first language with the responses corresponding to the contents of the 1^{st} party conversation and/or the first teaching instruction 420A.

The user may press the “voice input” button 450 to input conversation content via a microphone. The user computer 130 may convert the speech voice input into text by utilizing common voice recognition functionality. The speech voice recognition functionality may be performed on the user computer 130, or the voice signals may be transmitted to a remote location for recognition. For example, the user computer 130 may directly transmit the voice signals back to the server 110 which is responsible for recognizing the speech voice signals and converting into the first language.

In an alternative embodiment, the user may input the conversation content via other input devices, such as mouse or keyboard. When the conversation content of the user is shown by the user computer, it may be played by the speaker again. The speech voice recognition and the input functionalities may be restricted to the first language.

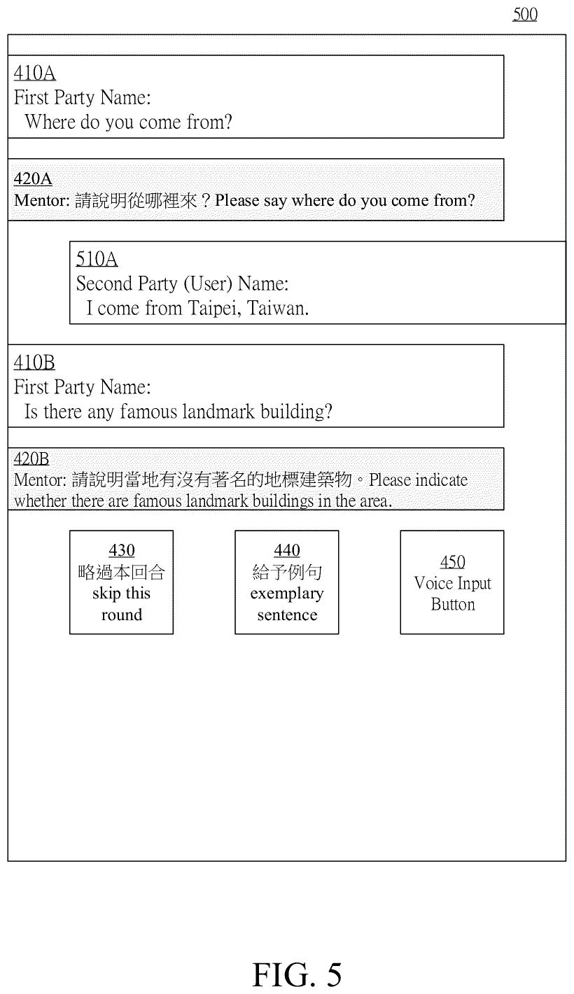

Please refer to FIG. 5, which is a schematic diagram illustrates the content of a conversation window 500 according to an embodiment of the present application. The content of the conversation window 500 includes a user conversation 510A (may be referred as a 2^{nd} party conversation or a student conversation) of the first round. The server 110 is configured to determine whether the user's conversation 510 matches with the content of the first teaching instruction 420A. In one embodiment, the server 110 may determine whether the user's conversation 510A matches with one of sentence patterns in multiple exemplary sentences in the first language. When there is a match, the server 110 would proceed to a next round of the conversation. In an alternative embodiment, the server 110 may input the user's conversation 510A and the 1^{st} party conversation 410A into a pre-trained AI model for determination. For example, a LLM implemented by the AI server 140 as shown in FIG. 1 may include a classifier for comparing the 2^{nd} party conversation 510A with the 1^{st} party conversation 410A to determine whether they match. Person having ordinary skill in the art can understand that the present application does not limit the use of any specific technologies to determine on the user's conversation 510A.

When the match is determined, the content of the conversation window 500 would appear a 1^{st} party conversation and first teaching instruction 420B of the second round. Similar to the contents of the conversation window 400, three buttons may be included in the contents of the conversation window 500. They are the “skip this round” button 430, the “exemplary sentence” button 440, and the “voice input” button 450, respectively.

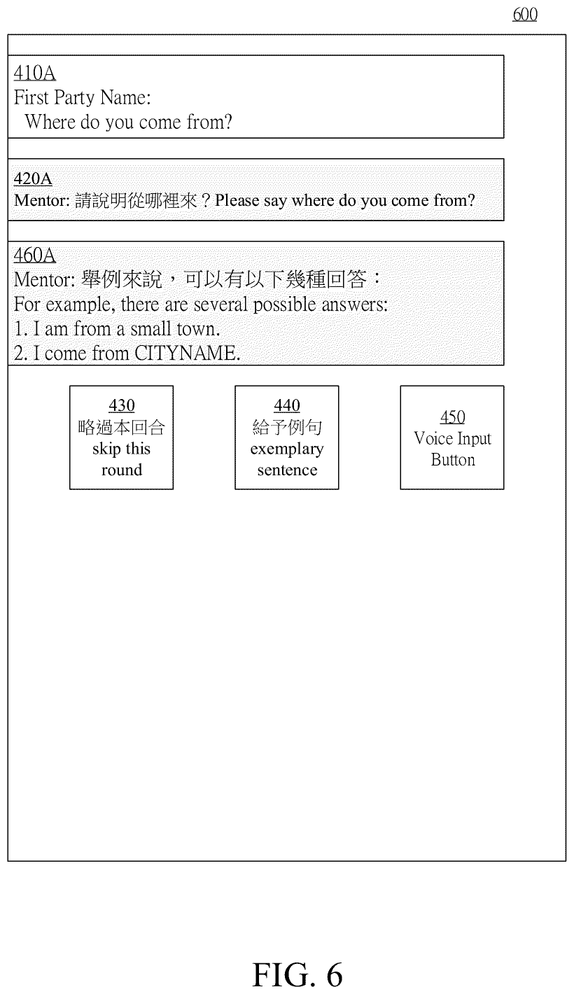

Please refer to FIG. 6, which is a schematic diagram illustrates the content of conversation window 600 in accordance with an embodiment of the present application. In the embodiment as shown in FIG. 4, when the user presses the “exemplary sentence” button 440, i.e., an instruction to display the second teaching instruction button, a second teaching instruction 460A would be shown below the first teaching instruction 420A as shown in the content of the conversation window 600. In the second teaching instruction 460A, two exemplary sentences are included. The user may read the exemplary sentences in the second teaching instruction 460A and responds with a slight variant of the exemplary sentences.

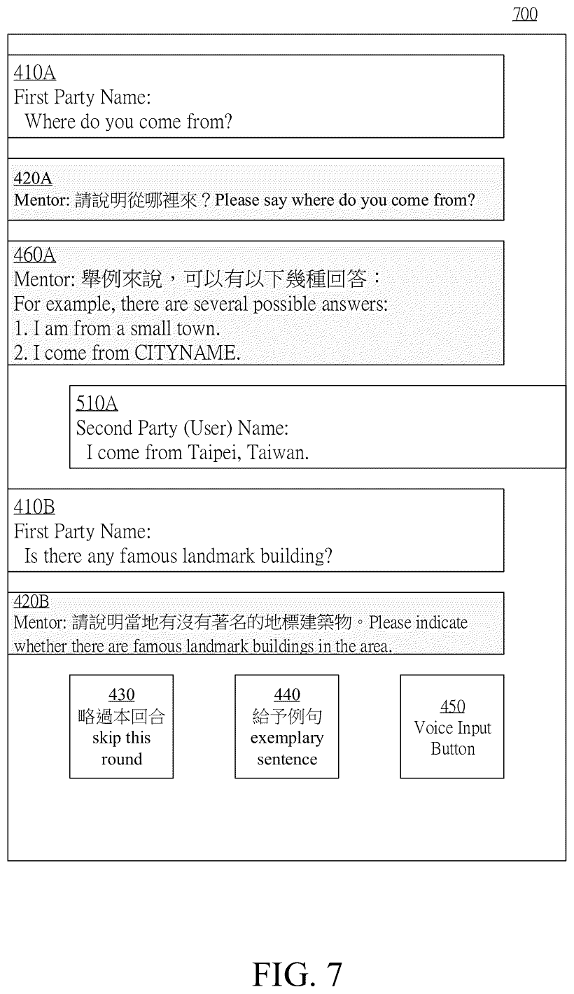

Please refer to FIG. 7, which is a schematic diagram illustrates the content of conversation window 700 in accordance with an embodiment of the present application. In the embodiment as shown in FIG. 6, the user referenced the second exemplary sentence of the second teaching instrument 460A and responded accordingly. Hence, as a result, the server 110 determines that the user conversation 510A matches with the 1^{st} party conversation 410A or the second teaching instruction 460A. After that, the server 110 prompts the 1st party conversation 410B and the first teaching instruction 420B of the second round.

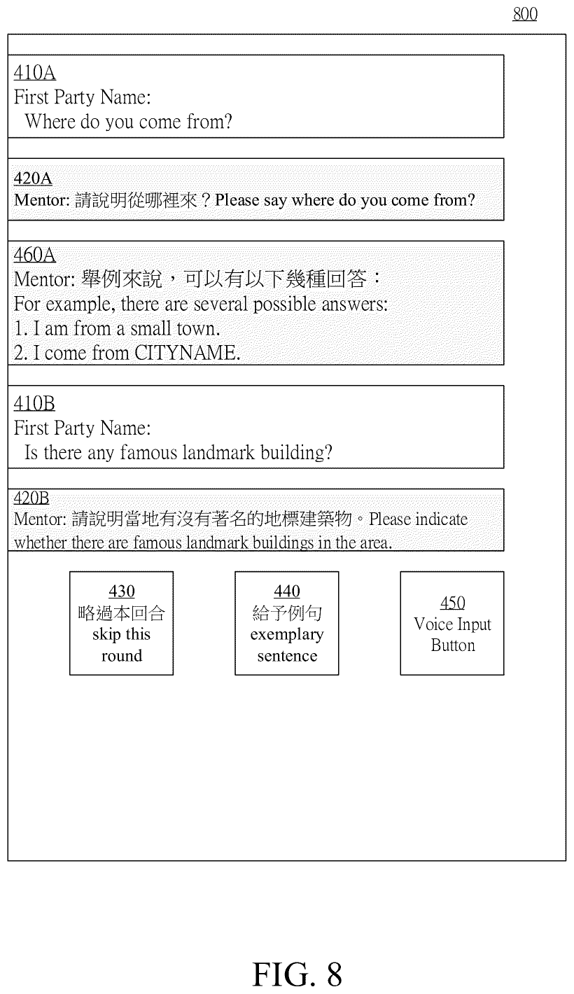

Please refer to FIG. 8, which is a schematic diagram illustrates the content of a conversation window 800 in accordance with an embodiment of the present application. In the embodiment as shown in FIG. 6, the user presses the “skip this round” button 430, the server 110 may prompt the second teaching instruction 460A of the first round. And without waiting for the input from the user, the server proceeds to the second round. i.e., prompting the 1st party conversation 410B and the first teaching instruction 420B of the second round.

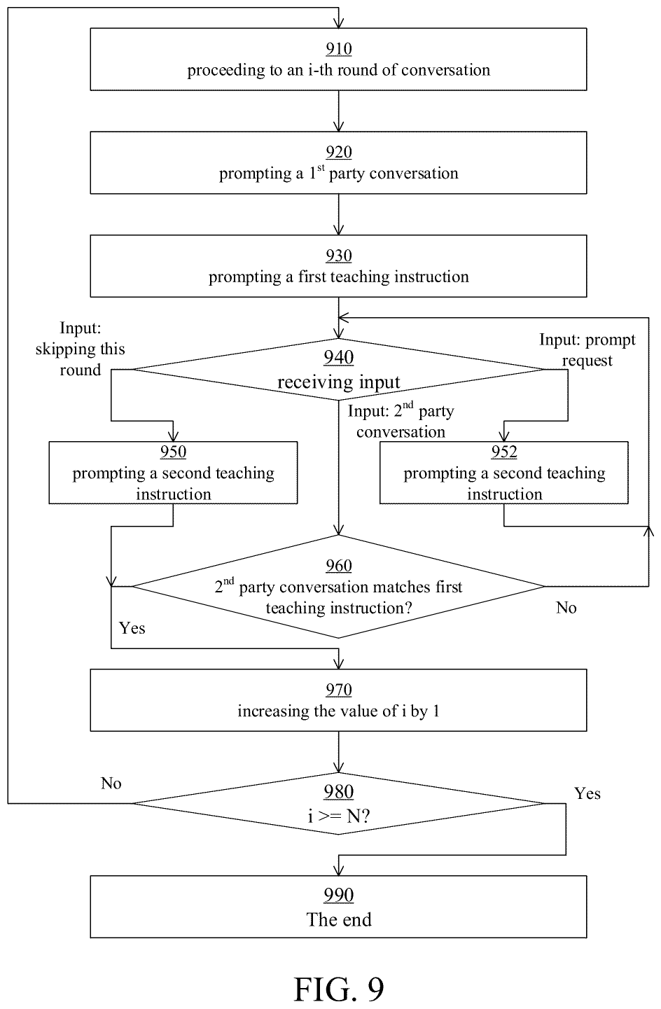

Please refer to FIG. 9, which depicts a flowchart diagram of a conversational teaching method 900 in accordance with an embodiment of the present application. The conversational teaching method 900 may be applicable to the conversational teaching system 100 as shown in FIG. 1. Especially it may be implemented as software executed by the server 110 in conjunction of the user computer 130. If there is no causal relationship between any two steps, the application does not limit the execution order of the steps. The conversational teaching method 900 may be applicable to a conversational script. Each of the script comprises N rounds, where N is an integer larger than 1. A variant i may be initiated as 1. The conversational teaching method 900 may begin with step 910.

Step 910: proceeding to an i-th round of conversation.

Step 920: transmitting a 1^{st} party conversation of the i-th round to a user computer 130 via a network 120 and may having the user computer 130 prompt a user with the 1st party conversation through sound and/or image. It is to let a speaker and/or a display to play and/or to show the 1^{st} party conversation.

Step 930: transmitting a first teaching instruction of the i-th round to the user computer 130 via the network 130 and may having the user computer 130 prompt the first teaching instruction to the user through sound and/or image.

Step 940: receiving the user's input and proceeding to following steps according to the user's input. When the user's input is a “skip this round” command, the flow proceeds to step 950. When the user's input is a prompt request of the second teaching instruction, the flow proceeds to step 952. When the user inputs a 2^{nd} party conversation (or so-called user conversation) via voice recognition or keyboard, the flow proceeds to step 960.

Step 950: transmitting a second teaching instruction of the i-th round to the user computer 130 and having the user computer 130 prompt the user with the second teaching instruction through sound and/or image. Next, the flow proceeds to step 970.

Step 952: transmitting the second teaching instruction of the i-th round to the user computer 130 and having the user computer 130 prompt the user with the second teaching instruction through sound and/or image. Next, the flow returns to step 940.

Step 960: determining whether the 2^{nd} party conversation inputted by the user matches with the 1^{st} party conversation or not. As described above, when these two are matched, the flow proceeds to step 970. Otherwise, the flow returns to step 940.

Step 970: increasing the variable i's value by 1. Next, the flow proceeds to step 980.

Step 980: determining whether the variable i's value is larger than or equals to N. When the variable i's value is larger than or equals to N, the flow proceeds to step 990. Otherwise, the flow returns to step 910 and proceeds to the next round.

Step 990: ending the conversational teaching method 900.

As explained above, without prompting teaching instruction, conversation contents of a previous round easily deviate from the script. This makes it difficult to proceed to a next round conversation of the script. When a student experiences the aforementioned situation, he may not think learning through the traditional conversational teaching is an enjoyable experience.

In one embodiment, the first teaching instruction at step 930 and/or the second teaching instruction at step 950/952 may be pre-edited and stored in the script. In an alternative embodiment, the first teaching instruction at step 930 and/or the second teaching instruction at step 950/952 may be generated by AI in real time. For example, the AI may be a well-trained LLM which generates the first and/or the second teaching instructions according to the 1^{st} party conversation of the round. In a variant, the first and/or the second teaching instructions are generated according to multiple 1^{st} party conversations of multiple rounds. In another variant, multiple 1^{st} party conversations of multiple rounds may be utilized to generate the first and/or the second teaching instructions.

The AI may be implemented in the server 110 as shown in FIG. 1 or the server 110 asks another server 140 which implements a LLM via API (application programming interface) or other channels for generation.

When using the AI model to generate teaching instructions, the generation may be based on the perspective of either the 1^{st} party or the 2^{nd} party. For example, from the perspective of the first party, the AI may convert the subject of the 1st party conversation. When the content of the 1^{st} party conversation is about asking if the user wants to do something, e.g., eating lunch together, the AI may provide teaching instructions from both positive and negative perspectives. The positive teaching instruction may include an exemplary sentence of how to express oneself when the user wants to do something (e.g., eating launch). The negative teaching instruction may include another exemplary sentence of how to decline the proposal when the user does not want to do something (e.g., eating launch). In addition to the aforementioned positive and negative responses, when there are many options of possible answers, the AI may expand the breadth of responses for each option according to the learned contextual knowledges.

Therefore, the conversation teaching method provided by the present application particularly adds the first teaching instruction at step 930 and/or the second teaching instruction at step 950/952 into the conversations. Their functions include but are not limited to following:
1. Limit the range of the user's response to keep the conversation content can be focused on the objective of the teaching instruction of the present round (e.g., the teaching instruction is about asking where the user works.)
2. Provide some suggestions to the user (in some circumstances, suggest the user asks questions proactively or make relevant responses.)
3. Provide an answer (provide a correct answer or a possible rephrasing sentence corresponding to a question provided in the 1^{st} party conversation.)
4. Guide the user to read relevant data or to enter another conversation topic (when the user's answer is not correct, suggest another topic based on its shortcomings.)
5. Give the user some words of encouragement and commendation to boost morale.

This demonstrates the important function provided by the teaching instructions of the conversational teaching method provided by the present application is one of significant inventive features of the present application. Hence, the present application provides a conversational teaching method and system which allows students to have more appropriate responses with the framework of teaching instructions to enhance their learning effectiveness and enjoyment of conversational teaching.

According to an embodiment of the present application, a conversational teaching method is provided. The method comprising: receiving a teaching script, wherein the teaching script includes N rounds, N is a natural number larger than 1, and setting a value of a variable i is 1, where 1<=i<=N; and when i<=N, executing following steps of a i-th round: transmitting a 1St party conversion of the i-th round of the N rounds to a user computer via a network, and having the user computer prompt the 1^{st} party conversion; transmitting a first teaching instruction to the user computer via the network, and having the user computer prompt the first teaching instruction; receiving a 2^{nd} party conversation from the user computer via the network; determining whether the 2^{nd} party conversation matches with at least one of the 1^{st} party conversation and the first teaching instruction; and when it is determined that the 2^{nd} party conversation matches with at least one of the 1^{st} party conversation and the first teaching instruction, increasing the value of the variable i by 1.

Preferably, in order to have the user to practice first language according to familiar second language, wherein the 1^{st} party conversation and the 2^{nd} party conversation are presented in a first language, and the first teaching instruction is presented in a second language.

Preferably, in order to have the user to practice listen and reading comprehension, wherein the step of having the user computer prompt the 1^{st} party conversion in the i-th round comprises one or any combination of following: showing the 1st party conversion in a conversation window by a display; and playing voices of the 1st party conversion by a speaker.

Preferably, in order to have the user to practice speaking of the first language, wherein the step of receiving the 2^{nd} party conversation of the i-th round comprises one of following steps and prompting the 2^{nd} party conversation: receiving voices by a microphone and converting the voices into the 2^{nd} party conversation by voice recognition; and receiving text of the 2^{nd} party conversation by an input device.

Preferably, in order to have the user to practice exemplary answers, wherein when it is determined that the 2^{nd} party conversation does not match with at least one of the 1^{st} party conversation and the first teaching instruction, the conversational teaching method further comprises transmitting a second teaching instruction of the i-th round to the user computer and having the user computer prompt the second teaching instruction, wherein the second teaching instruction includes an example presented in the first natural language.

Preferably, in order to have the user to answer closed to a target, wherein the step of determining whether the 2^{nd} party conversation matches with at least one of the 1^{st} party conversation and the first teaching instruction further comprises comparing the 2^{nd} party conversation with multiple answers of the i-th round, when the 2^{nd} party conversation is like one of the answers, it is determined that the 2^{nd} party conversation matches with at least one of the 1^{st} party conversation and the first teaching instruction of the i-th round.

Preferably, wherein the step of determining whether the 2^{nd} party conversation matches with at least one of the 1^{st} party conversation and the first teaching instruction further comprises: inputting the 2^{nd} party conversation into an AI model for inferencing, when a result of the inferencing matches the first teaching instruction, it is determined that the 2^{nd} party conversation matches at least one of the 1^{st} party conversation and the first teaching instruction of the i-th round.

Preferably, in order to have the user continue the conversational teaching when the user has no idea, the conversational teaching method further comprises one or any combination of following step after the step of prompting the first teaching instruction of the i-th round: prompting an optional command of skipping the i-th round; and prompting an optional command of showing a second teaching instruction of the i-th round.

Preferably, in order to have the user to skip the current round, the conversational teaching method further comprises: receiving the optional command of skipping the i-th round from an input device of the user computer via the network; transmitting the second teaching instruction of the i-th round to the user computer via the network, and having the user computer prompt the second teaching instruction of the i-th round via the network; and increasing the value of the variable i by 1 to end the i-th round, and proceeding to an i+1 round.

Preferably, in order to have the user to read a new teaching instruction, the conversational teaching method further comprises: receiving the optional command of showing the second teaching instruction of the i-th round from an input device of the user computer via the network; and transmitting the second teaching instruction to the user computer via the network, and having the user computer prompt the second teaching instruction of the i-th round.

Preferably, in order to simplify preparation of the teaching script, wherein the first teaching instruction of the i-th round is generated by an AI model according to the 1^{st} party conversation of the i-th round.

Preferably, in order to simplify preparation of the teaching script and to consider the continuity of the teaching script, wherein the first teaching instruction of the i-th round is generated by an AI model according to the 1^{st} party conversation of a first round through the 1^{st} party conversation of the i-th round.

Preferably, in order to simplify preparation of the teaching script and to consider the continuity of the teaching script, wherein the second teaching instruction of the i-th round is generated by an AI model according to the 1^{st} party conversation and the first teaching instruction of the i-th round.

According to an embodiment of the present application, a server of a conversational teaching system is provided. The server comprises a processor for executing instructions stored in non-volatile memory for realizing the conversational teaching method.

According to an embodiment of the present application, a conversational teaching system is provided for realizing the conversational teaching method. The conversational teaching system comprises the server and the user computer.

In summarized, the present application provides a conversational teaching method and system which allows students to have more appropriate responses with the framework including at least one teaching instruction to enhance their learning effectiveness and enjoyment in the conversational teaching.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A conversational teaching method, comprising:
receiving a teaching script, wherein the teaching script includes N rounds, N is a natural number larger than 1, and setting a value of a variable i is 1, where 1<=i<=N; and
when i<=N, executing following steps of a i-th round:
transmitting a 1^{st} party conversion of the i-th round of the N rounds to a user computer via a network, and having the user computer prompt the 1^{st} party conversion;
transmitting a first teaching instruction to the user computer via the network, and having the user computer prompt the first teaching instruction;
receiving a 2^{nd} party conversation from the user computer via the network;
determining whether the 2^{nd} party conversation matches with at least one of the 1^{st} party conversation and the first teaching instruction; and
when it is determined that the 2^{nd} party conversation matches with at least one of the 1^{st} party conversation and the first teaching instruction, increasing the value of the variable i by 1.

2. The conversational teaching method as recited in claim 1, wherein the 1^{st} party conversation and the 2^{nd} party conversation are presented in a first language, and the first teaching instruction is presented in a second language.

3. The conversational teaching method as recited in claim 1, wherein the step of having the user computer prompt the 1^{st} party conversion in the i-th round comprises one or any combination of following:
showing the 1st party conversion in a conversation window by a display; and
playing voices of the 1st party conversion by a speaker.

4. The conversational teaching method as recited in claim 1, wherein the step of receiving the 2^{nd} party conversation of the i-th round comprises one of following steps and prompting the 2^{nd} party conversation:
receiving voices by a microphone and converting the voices into the 2^{nd} party conversation by voice recognition; and
receiving text of the 2^{nd} party conversation by an input device.

5. The conversational teaching method as recited in claim 2, wherein when it is determined that the 2^{nd} party conversation does not match with at least one of the 1^{st} party conversation and the first teaching instruction, the conversational teaching method further comprises transmitting a second teaching instruction of the i-th round to the user computer and having the user computer prompt the second teaching instruction, wherein the second teaching instruction includes an example presented in the first natural language.

6. The conversational teaching method as recited in claim 1, wherein the step of determining whether the 2^{nd} party conversation matches with at least one of the 1^{st} party conversation and the first teaching instruction further comprises comparing the 2^{nd} party conversation with multiple answers of the i-th round, when the 2^{nd} party conversation is like one of the answers, it is determined that the 2^{nd} party conversation matches with at least one of the 1^{st} party conversation and the first teaching instruction of the i-th round.

7. The conversational teaching method as recited in claim 1, further comprises: inputting the 2^{nd} party conversation into an AI model for inferencing, when a result of the inferencing matches the first teaching instruction, it is determined that the 2^{nd} party conversation matches at least one of the 1^{st} party conversation and the first teaching instruction of the i-th round.

8. The conversational teaching method as recited in claim 1, further comprises one or any combination of following step after the step of prompting the first teaching instruction of the i-th round:
prompting an optional command of skipping the i-th round; and
prompting an optional command of showing a second teaching instruction of the i-th round.

9. The conversational teaching method as recited in claim 8, further comprises:
receiving the optional command of skipping the i-th round from an input device of the user computer via the network;
transmitting the second teaching instruction to the user computer, and
transmitting the second teaching instruction of the i-th round to the user computer via the network; and
increasing the value of the variable i by 1 to end the i-th round and proceeding to an i+1 round.

10. The conversational teaching method as recited in claim 8, further comprises:
receiving the optional command of showing the second teaching instruction of the i-th round from an input device of the user computer via the network; and
transmitting the second teaching instruction to the user computer via the network and having the user computer prompt the second teaching instruction of the i-th round.

11. The conversational teaching method as recited in claim 1, wherein the first teaching instruction of the i-th round is generated by an AI model according to the 1^{st} party conversation of the i-th round.

12. The conversational teaching method as recited in claim 1, wherein the first teaching instruction of the i-th round is generated by an AI model according to the 1^{st} party conversation of a first round through the 1^{st} party conversation of the i-th round.

13. The conversational teaching method as recited in claim 8, wherein the second teaching instruction of the i-th round is generated by an AI model according to the 1^{st} party conversation and the first teaching instruction of the i-th round.

14. A server of a conversational teaching system, comprising a processor for executing instructions stored in non-volatile memory for realizing the conversational teaching method as recited in claim 1.

15. A conversational teaching system, comprising the server and the user computer as recited in claim 14.
